(19) United States
(12) Patent Application Publication
(10) Pub. No.: US 2023/0086452 A1
(43) Pub. Date: Mar. 23, 2023

(54) TORQUE OUTPUT TOOL AND CONTROL METHOD FOR A TORQUE OUTPUT TOOL

(71) Applicant: Nanjing Chervon Industry Co., Ltd., Nanjing (CN)

(72) Inventor: Baofeng Fan, Nanjing (CN)

(21) Appl. No.: 17/893,615

(22) Filed: Aug. 23, 2022

(30) Foreign Application Priority Data
Sep. 23, 2021 (CN) 202111110578.9

(51) Int. Cl. B25B 21/00

(52) U.S. Cl. CPC B25B 21/00

(57) ABSTRACT

A torque output tool includes an operating mechanism, a load determination device, an operation amount determination device, and a control mechanism. The operating mechanism is used for a user to operate. The load determination device is used for determining a load. The operation amount determination device is used for determining a current operation amount of an operation mechanism. The control mechanism is used for increasing a rotational speed of a motor in the case where the load gradually increases and the current operation amount is unchanged.

### RELATED APPLICATION INFORMATION

This application claims the benefit under 35 U.S.C. § 119(a) of Chinese Patent Application No. CN 202111110578.9, filed on Sep. 23, 2021, which application is incorporated herein by reference in its entirety.

### TECHNICAL FIELD

The present application relates to the technical field of power tools and, in particular, to a torque output tool and a control method for a torque output tool.

### BACKGROUND

A screwdriver is a common household tool and has the advantages of being quick and light, cheap and practical, and applicable to a wide range of people.

A user usually uses an impact screwdriver with an impact function so that when a screw is tightened, an output shaft of the impact screwdriver is driven by a motor to apply a circumferential impact force to the screw in a predetermined rhythm, thereby increasing working efficiency. However, when encountering a large load in a low speed state, the impact screwdriver is prone to a locked-rotor and cannot work due to limited output torque.

### SUMMARY

The present application provides a torque output tool and a control method for a torque output tool, which can reduce a probability of a locked-rotor of the torque output tool. The technical solutions are described below.

In one aspect, an example of the present application provides a torque output tool including a motor, a housing, an output shaft, and a gearbox assembly. The motor includes a motor shaft rotatable around a first axis. The housing includes an accommodation portion for forming an accommodation space for accommodating the motor. The output shaft is drivable by the motor to rotate around the first axis. The gearbox assembly is used for transmitting power between the motor and the output shaft. The torque output tool further includes an operation mechanism, a load determination unit, an operation amount determination unit, and a control device. The operation mechanism is used for a user to operate. The load determination unit is used for determining a load. The operation amount determination unit is used for determining a current operation amount of the operation mechanism. The control device is used for increasing a rotational speed of the motor in the case where the load gradually increases and the current operation amount is unchanged.

In another aspect, an example of the present application provides a torque output tool including a motor, a housing, an output shaft, a gearbox mechanism, an operating mechanism, and a control mechanism. The motor includes a motor shaft rotatable around a first axis. The housing includes an accommodation portion for forming an accommodation space for accommodating the motor. The output shaft is used for outputting torque. The gearbox mechanism is used for transmitting power between the motor and the output shaft. The operating mechanism is used for a user to operate. The control mechanism is used for determining a load and a current operation amount of the operating mechanism and increasing a rotational speed of the motor in the case where the load gradually increases and the current operation amount is unchanged.

In another aspect, an example of the present application provides a control method for a torque output tool. The method includes steps described below. A load is determined. A current operation amount of an operation mechanism of the torque output tool is determined. A rotational speed of a motor of the torque output tool is increased in the case where the load gradually increases and the current operation amount is unchanged.

### BRIEF DESCRIPTION OF DRAWINGS

To illustrate technical solutions of the present application more clearly, the following descriptions reference the drawings which illustrate only part of the examples of the present application. Those of ordinary skill in the art may obtain other examples based on the drawings described below on the premise that no creative work is done.

FIG. 1 is a schematic view of a torque output tool according to an example of the present application;

FIG. 2 is a flowchart of a control method for a torque output tool according to an example of the present application; and

FIG. 3 is a block diagram of a motor control device of a torque output tool according to an example of the present application.

### DETAILED DESCRIPTION

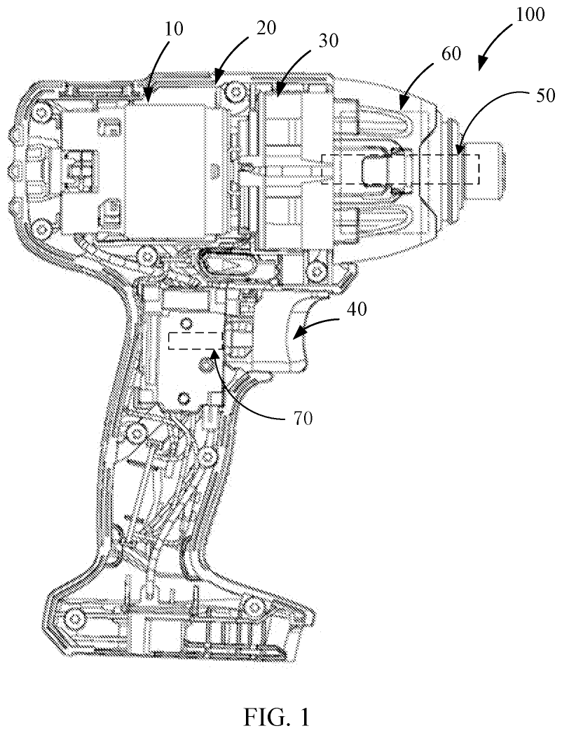

Referring to FIG. 1, FIG. 1 is a schematic view of a torque output tool according to an example of the present application. A torque output tool 100 includes a motor 10, a housing 20, a gearbox mechanism 30, and an output shaft 50.

For ease of description, in FIG. 1, a screwdriver is used as an example of the torque output tool, which is not to limit the present application. The torque output tool is capable of outputting torque. In some examples, the torque output tool includes an electric drill, the screwdriver, and a wrench. The torque output tool may also be a multi-function tool with functions of both the screwdriver and the electric drill, or the torque output tool may also be a multi-function tool with functions of both the wrench and the screwdriver, or the torque output tool may also be a multi-function tool with functions of both the wrench and the electric drill, which is not limited in the examples of the present application. In some examples, the torque output tool also has an impact function. In this case, the torque output tool may include an impact electric drill, an impact screwdriver, and an impact wrench.

The housing 20 is used for accommodating various components in the torque output tool and may include a handle portion and an accommodation portion. The housing 20 includes the accommodation portion for forming an accommodation space for accommodating the motor, and the motor may be disposed in the accommodation space formed by the accommodation portion. The handle portion is used for a user to hold.

The motor 10 includes a motor shaft rotatable around a first axis. The motor 10 is disposed in the housing 20. The motor 10 is used for outputting a driving force and for driving the output shaft 50 to rotate around the first axis. In a possible implementation manner, the motor 10 is a direct current (DC) brushless motor. The motor 10 includes a rotor and a stator.

The output shaft 50 can be driven by the motor 10 to rotate around an output axis. In this example, the output axis coincides with the first axis. In other alternative examples, the output axis may be parallel to the first axis. In other alternative examples, the output axis may be disposed at an angle relative to the first axis. The output shaft 50 may be used for outputting torque.

The gearbox mechanism 30 is used for transmitting power between the motor 10 and the output shaft 50. The gearbox mechanism 30 is disposed between the motor and the output shaft 50, and through the gearbox mechanism 30, the motor 10 drives the output shaft 50 to rotate so as to output torque. The gearbox mechanism 30 decelerates output of the motor shaft for rotational output.

In some examples, the torque output tool 100 further includes an impact mechanism 60. The gearbox mechanism 30 is coupled to the motor 10 and the impact mechanism 60 and used for transmitting output of the motor 10 to the impact mechanism 60. The impact mechanism 60 includes an impact force generation mechanism for generating an impact force.

In some examples, the torque output tool 100 further includes a fan. The fan is rotatably disposed in the accommodation space formed by the accommodation portion. When the fan rotates, the fan can generate an airflow for dissipating heat for the torque output tool. In some examples, the fan is mounted onto the motor shaft, and when the motor 10 is operating, the motor shaft drives the fan to rotate together, thereby dissipating heat. In a direction of the first axis, the fan may also be disposed between the motor 10 and the gearbox mechanism. The housing is provided with an airflow inlet and an airflow outlet for ventilation, and the airflow inlet connects the inside and outside of the housing and the airflow outlet connects the inside and outside of the housing. In a direction parallel to the first axis, the airflow outlet is disposed at a first axial position of the accommodation portion corresponding to an axial position of the fan, and the airflow outlet is also disposed between the airflow inlet and the gearbox mechanism. In some examples, the airflow inlet is disposed at a second axial position of the accommodation portion corresponding to an axial position of a rear end of the motor 10 farther from the fan, that is, an axial position of the airflow inlet is substantially the same as the axial position of the rear end of the motor, and an axial position of the airflow outlet is substantially the same as the axial position of the fan. In this manner, when the fan rotates, the airflow can flow into the accommodation space through the airflow inlet, then flow through the motor 10 to dissipate heat for the motor, and then flow out of the housing through the airflow outlet near the fan, thereby dissipating heat for the motor. At the same time, since the fan is disposed near the gearbox mechanism so that heat in the proximity of the gearbox mechanism can also be dissipated by the fan or taken away by the airflow.

FIG. 3 shows a control block diagram of the torque output tool 100. As shown in FIG. 3, the torque output tool 100 further includes a load determination device 310, an operation amount determination device 320, and a control device 330.

The operating mechanism 40 is used for the user to operate. The operating mechanism 40 may be mounted on the handle portion. When the user holds the handle portion, the user can trigger the operating mechanism 40 relatively conveniently, and the operating mechanism 40 may be configured to be a main trigger for starting up the torque output tool 100.

The load determination device 310 is used for determining a load. The operation amount determination device 320 is used for determining a current operation amount of the operating mechanism.

The current operation amount of the operating mechanism 40 refers to an operation amount of the operating mechanism 40 when the load determination device 310 determines the load. The operation amount of the operating mechanism 40 refers to a variation of the operating mechanism 40 relative to an initial state when the user currently operates the operating mechanism 40. The initial state refers to a state in which the operating mechanism 40 is not operated by the user. When the operating mechanism 40 is a trigger switch, the current operation amount of the operating mechanism 40 refers to a stroke amount of the operating mechanism 40 relative to the initial state when the user currently operates the operating mechanism 40.

The control device 330 is used for increasing a rotational speed of the motor 10 in the case where the load gradually increases and the current operation amount is unchanged.

The unchanged current operation amount of the operating mechanism 40 means that the operation amount of the operating mechanism 40 at a current moment is unchanged compared with that at a previous moment, that is, the current operation amount of the operating mechanism 40 is unchanged compared with an operation amount of the operating mechanism 40 at the previous moment, or a variation between the current operation amount of the operating mechanism 40 and the operation amount of the operating mechanism 40 at the previous moment is within a preset range, where the preset range may be set by a technician. The previous moment may be understood as a moment at which the operation amount of the operating mechanism 40 is determined most recently before the current moment. For example, an operation amount determined by the operation amount determination device 320 at the current moment is operation amount 1, and an operation amount determined by the operation amount determination device 320 at the previous moment is also operation amount 1. In this case, the current operation amount of the operating mechanism 40 is unchanged.

In some examples, the load determination device 310 and the operation amount determination device 320 may be in communication with the control device 330. When determining that the load gradually increases, the load determination device 310 sends a load increase signal to the control device 330, where the load increase signal is used for indicating that the load gradually increases. When determining that the current operation amount is unchanged, the operation amount determination device 320 sends an unchanged operation amount signal to the control device 330, where the unchanged operation amount signal is used for indicating that the current operation amount of the operating mechanism 40 is unchanged. When receiving the load increase signal and the unchanged operation amount signal, the control device 330 increases the rotational speed of the motor 10.

In the case where the load gradually increases and the current operation amount of the operating mechanism 40 is unchanged, since the operation amount of the operating mechanism 40 has a correspondence with a duty cycle that controls the rotational speed of the motor, if the current operation amount of the operating mechanism 40 is unchanged, a current rotational speed of the motor 10 may also be unchanged. However, the load gradually increases, and the current rotational speed of the motor 10 cannot adapt to the current load, easily causing a locked-rotor of the torque output tool 100. In the examples of the present application, the control device 330 automatically increases the rotational speed of the motor 10 in the case where the load gradually increases and the current operation amount is unchanged so that the rotational speed of the motor 10 adapts to the load, thereby reducing a probability of the locked-rotor of the torque output tool 100 and increasing the service life of the torque output tool 100.

In other alternative examples, the control device 330 may include the load determination device 310 and the operation amount determination device 320. That is, the load determination device 310 and the operation amount determination device 320 belong to the control device 330. Functions of the load determination device 310 and the operation amount determination device 320 may be implemented by the control device 330, and the control device 330 is used for determining the load; determining the current operation amount of the operating mechanism; and increasing the rotational speed of the motor in the case where the load gradually increases and the current operation amount is unchanged. The control device 330 may acquire the load and the operation amount of the operating mechanism at the current moment and a load and the operation amount of the operating mechanism at the previous moment; in the case where the load at the current moment is greater than the load at the previous moment, the control device 330 determines that the load gradually increases; and in the case where the variation between the current operation amount of the operating mechanism and the operation amount of the operating mechanism at the previous moment is within the preset range, the control device 330 determines that the current operation amount of the operating mechanism is unchanged.

For a beginner, the beginner cannot control the torque output tool 100 very well. When the load gradually increases, it is very likely that the beginner will not actively operate the operating mechanism 40. As a result, the torque output tool 100 is in a locked-rotor condition for a relatively long time and automatically enters on-load protection. At this time, the user cannot operate the torque output tool 100 to complete the operation, resulting in bad user experience for the beginner. In the examples of the present application, in the case where the load gradually increases and the operation amount of the operating mechanism 40 is unchanged, the rotational speed of the motor 10 is automatically increased so that the adjusted rotational speed of the motor 10 adapts to the gradually increased load. The operation is implemented before the torque output tool 100 enters the on-load protection, thereby avoiding the following case: the torque output tool 100 enters the on-load protection due to the locked-rotor for a long time and cannot work normally.

In some examples, the torque output tool 100 may further include other assemblies, for example, a power supply assembly and the like, which are not listed one by one in the examples of the present application.

To sum up, according to the technical solutions provided in the examples of the present application, in the case where the load gradually increases and the current operation amount is unchanged, the rotational speed of the motor 10 is automatically increased so that the rotational speed of the motor 10 adapts to the load, thereby reducing the probability of the locked-rotor of the torque output tool 100.

In the examples of the present application, the control device 330 is used for adjusting a current original pulse-width modulation (PWM) signal to a target PWM signal in the case where the load gradually increases and the current operation amount is unchanged, where the target PWM signal has a greater pulse width than the original PWM signal.

In some examples, the PWM signal may also be referred to as a PWM waveform.

Changing the PWM signal to control the duty cycle is equivalent to changing a voltage across the motor to change the rotational speed of the motor 10. The duty cycle refers to a ratio of power-on time to total time in one pulse cycle. The pulse width of the PWM signal affects the output power of the motor 10. In some examples, the larger the duty cycle of the PWM signal, the greater the output power and the rotational speed of the motor 10; the smaller the duty cycle of the PWM signal, the smaller the output power and the rotational speed of the motor 10.

In some examples, the operating mechanism 40 may be the trigger switch, the operation amount of the operating mechanism 40 is positively correlated with the duty cycle of the PWM signal of the motor 10, and the duty cycle of the PWM signal is positively correlated with the rotational speed of the motor 10. In the case where the operation amount of the operating mechanism 40 is relatively small, the duty cycle of the PWM signal is also relatively small, and at this time, the rotational speed of the motor 10 is also relatively small.

In some examples, the torque output tool 100 stores a mapping relationship between the operation amount of the operating mechanism 40 and the PWM signal, where the mapping relationship may be linear or non-linear, which is not limited in the examples of the present application.

In other alternative examples, the current operation amount of the operating mechanism 40 corresponds to the original PWM signal. The control device 330 processes the original PWM signal according to a preset rule to obtain the target PWM signal. For example, the preset rule may be that a PWM signal whose duty cycle is greater than a duty cycle of the original PWM signal in a second mapping relationship that is spaced from a first mapping relationship corresponding to the original PWM signal by a preset number of mapping relationships is determined to be the target PWM signal, where the preset number may be set by the technician and is a positive integer. For example, the preset number may be 1, 2, 3, or other values, which is not limited in the examples of the present application. If the second mapping relationship spaced from the first mapping relationship by the preset number of preset relationships does not exist among the mapping relationships, a PWM signal with the largest duty cycle in the mapping relationships may be determined to be the target PWM signal. It is assumed that the mapping relationships include mapping relationship 1: operation amount 1 corresponds to PWM signal 1, mapping relationship 2: operation amount 2 corresponds to PWM signal 2, mapping relationship 3: operation amount 3 corresponds to PWM signal 3, mapping relationship 4: operation amount 4 corresponds to PWM signal 4, and mapping relationship 5: operation amount 5 corresponds to PWM signal 5. If the original PWM signal is PWM signal 1 and the mapping relationship corresponding to the original PWM signal is mapping relationship 1, the control device 330 may determine that the second mapping relationship is mapping relationship 3, and the target PWM signal is PWM signal 3; if the original PWM signal is PWM signal 4 and the mapping relationship corresponding to the original PWM signal is mapping relationship 4, the control device 330 may determine that the second mapping relationship is mapping relationship 5, and the target PWM signal is PWM signal 5.

In other alternative examples, the current operation amount of the operating mechanism corresponds to the original PWM signal. The control device 330 determines a maximum PWM signal stored by the torque output tool to be the target PWM signal.

In the examples of the present application, the current operation amount of the operating mechanism is determined in the following manner: the operation amount determination device 320 is used for acquiring a first analog signal outputted by a sliding rheostat 70 coupled to the operating mechanism at a current moment and determining the current operation amount based on the first analog signal.

In the examples of the present application, the operating mechanism is coupled to the sliding rheostat 70. When the operating mechanism is in the initial state and a final state (in which the user operates the operating mechanism to a maximum movement position to which the operating mechanism can move), analog signals outputted by the sliding rheostat 70 are different. The operation amount determination device 320 may acquire a third analog signal outputted by the sliding rheostat 70 when the operating mechanism is in the final state and determine the current operation amount according to the third analog signal and the first analog signal. In some examples, when the operating mechanism is in the final state, the operation amount of the operating mechanism is operation amount 1, and then the current operation amount may be determined by the following formula: current operation amount=(first analog signal×operation amount 1)/third analog signal.

In the examples of the present application, the operation amount determination device 320 is further used for acquiring a second analog signal outputted by the sliding rheostat 70 at an earlier moment that is separated from the current moment by a preset time and determining that the current operation amount is unchanged in the case where a variation between the first analog signal and the second analog signal is within a preset range.

The preset moment is determined by a signal acquisition period of the operation amount determination device 320. For example, the preset moment earlier than the current moment refers to a moment that is one signal acquisition period earlier than the current moment, that is, the preset moment earlier than the current moment refers to the previous moment of the current moment. The preset moment may be determined by the technician, and the signal acquisition period may be 1 s, 2 s, 3 s, or other periods, which is not limited in the examples of the present application.

When the variation between the current operation amount of the operating mechanism and the operation amount of the operating mechanism at the previous moment is within the preset range, the operation amount determination device 320 determines that the current operation amount is unchanged, where the preset range may be determined by the technician. For example, the preset range may be 0 to 0.5. Of course, the preset range may be set according to the precision of the operating mechanism, which is not limited in the examples of the present application.

In the examples of the present application, whether the load gradually increases may be determined in the following manner: the load determination device 310 is further used for acquiring the current rotational speed of the motor and determining that the load gradually increases in the case where the current rotational speed decreases.

When the load gradually increases, the current rotational speed of the motor decreases. Therefore, the load determination device 310 may determine whether the load gradually increases according to the current rotational speed of the motor.

In other alternative examples, the load determination device 310 acquires the current rotational speed of the motor and a rotational speed of the motor at the previous moment and determines that the current rotational speed decreases in the case where the current rotational speed is less than the rotational speed at the previous moment.

The rotational speed of the motor at the previous moment may refer to a rotational speed of the motor at an earlier moment that is separated from the current moment by a preset time. The preset moment is determined by a rotational speed acquisition period of the load determination device 310. The rotational speed acquisition period may be determined by the technician.

In other alternative examples, the load determination device 310 acquires the current rotational speed of the motor and all rotational speeds of the motor within a target time period before the current moment and determines that the current rotational speed decreases in the case where all the rotational speeds of the motor within the target time period and the current rotational speed of the motor show a decrease trend.

In other alternative examples, the control device 330 is used for increasing the rotational speed of the motor in the case where the motor operates at an initial startup rotational speed, the load gradually increases, and the current operation amount is unchanged, where the current operation amount corresponds to the initial startup rotational speed.

The initial startup rotational speed refers to a speed at which the motor is just started up. In the case where the operation amount by which the user operates the operating mechanism is relatively small, the motor operates at the initial startup rotational speed.

In other alternative examples, the initial startup rotational speed of the motor is less than or equal to 100 revolutions per minute (rpm).

In the examples of the present application, the control device 330 is further used for controlling the motor at a first PWM frequency in the case where the motor operates at the initial startup rotational speed and controlling the motor at a second PWM frequency in the case where the motor does not operate at the initial startup rotational speed, where the first PWM frequency is lower than the second PWM frequency.

In some examples, the first PWM frequency and the second PWM frequency correspond to the same pulse width.

In the examples of the present application, the first PWM frequency is lower than the second PWM frequency, and in the case where the motor operates at the initial startup rotational speed, the motor is controlled at a low PWM frequency so that the motor can be initially started at a relatively low rotational speed.

In the examples of the present application, in the case where the motor operates at 100 rpm or less, the first PWM frequency is 1 to 8 kHz; and in the case where the motor does not operate at 100 rpm or less, the second PWM frequency is greater than or equal to 10 kHz.

The user manually operates the operating mechanism to different positions or by different stroke distances to obtain a low-speed working condition desired by the user so that the motor has a relatively low speed. In this manner, a screw installed in a tool head or an end fastener enters the wood at a relatively low speed, thereby stabilizing the screw, and then the motor operates normally after the screw stabilizes. If an operator triggers the operating mechanism by a maximum operation amount when the torque output tool starts to operate, the control device 330 controls a driver circuit with the maximum PWM signal to make the motor rotate at a high speed. At this time, tool accessories such as screws are easily detached from the head or end (that is, the tool head) of the torque output tool, and the torque output tool cannot operate normally. In addition, in the case where a tool accessory such as the screw is relatively long, if the screw is impacted in the final state before the screw sufficiently enters the material, the long screw may be deflected due to a sharp change of the load at the beginning of the impact, causing the screw to be detached from the material or the tool head and damaging the material, the tool head, and the screw. However, when encountering a large load in a low speed state, the torque output tool is prone to the locked-rotor and cannot work due to limited output torque. Therefore, in the examples of the present application, in the case where the motor operates at the initial startup rotational speed, the load gradually increases, and the current operation amount is unchanged, the rotational speed of the motor is automatically increased, thereby reducing the probability of the locked-rotor when the operation amount of the operating mechanism is relatively small.

The following is a method example of the present application. For details not disclosed in the method example of the present application, reference may be made to a product example of the present application.

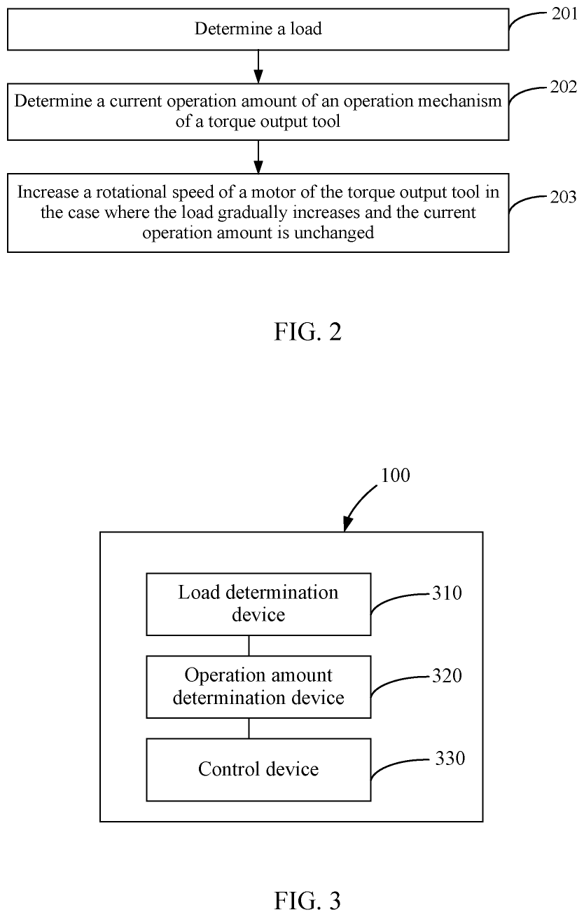

Referring to FIG. 2, FIG. 2 is a flowchart of a control method for a torque output tool according to an example of the present application. The method may include the steps described below.

In step 201, a load is determined.

In step 202, a current operation amount of an operating mechanism of the torque output tool is determined.

In step 203, a rotational speed of a motor of the torque output tool is increased in the case where the load gradually increases and the current operation amount is unchanged.

In the examples of the present application, the rotational speed of the motor may be implemented in the manner described below.

A current original PWM signal is adjusted to a target PWM signal in the case where the load gradually increases and the current operation amount is unchanged, where the target PWM signal has a greater pulse width than the original PWM signal.

In the examples of the present application, step 202 includes the sub-steps described below.

Firstly, a first analog signal is acquired which is outputted by a sliding rheostat coupled to the operating mechanism at a current moment.

Secondly, the current operation amount is determined based on the first analog signal.

In the examples of the present application, the method may further include the steps described below.

A second analog signal is acquired which is outputted by the sliding rheostat at an earlier moment that is separated from the current moment by a preset time.

In the case where a variation between the first analog signal and the second analog signal is within a preset range, it is determined that the current operation amount is unchanged.

In the examples of the present application, the method may further include the steps described below.

A current rotational speed of the motor is acquired.

In the case where the current rotational speed decreases, it is determined that the load gradually increases.

In the examples of the present application, the rotational speed of the motor is implemented in the following manner: the rotational speed of the motor is increased in the case where the motor operates at an initial startup rotational speed, the load gradually increases, and the current operation amount is unchanged, where the current operation amount corresponds to the initial startup rotational speed.

In the examples of the present application, the initial startup rotational speed of the motor is less than or equal to 100 rpm.

In the examples of the present application, the method may further include the steps described below.

In the case where the motor operates at the initial startup rotational speed, the motor is controlled at a first PWM frequency.

In the case where the motor does not operate at the initial startup rotational speed, the motor is controlled at a second PWM frequency, where the first PWM frequency is lower than the second PWM frequency.

In the examples of the present application, in the case where the motor operates at 100 rpm or less, the first PWM frequency is 1 to 8 kHz.

In the case where the motor does not operate at 100 rpm or less, the second PWM frequency is greater than or equal to 10 kHz.

To sum up, according to the technical solutions provided in the examples of the present application, in the case where the load gradually increases and the current operation amount is unchanged, the rotational speed of the motor is automatically increased so that the rotational speed of the motor adapts to the load, thereby reducing the probability of the locked-rotor of the torque output tool.

A device example of the present application is described below and may be used for performing the method example of the present application. For details not disclosed in the device example of the present application, reference may be made to the product example of the present application.

To sum up, according to the technical solutions provided in the examples of the present application, in the case where the load gradually increases and the current operation amount is unchanged, the rotational speed of the motor is automatically increased so that the rotational speed of the motor adapts to the load, thereby reducing the probability of the locked-rotor of the torque output tool.

It is to be noted that the device provided in the preceding example, when implementing its functions, is exemplified merely by the division of the preceding functional devices, and in practical applications, the preceding functions may be performed by different functional devices according to needs, that is, the structure of the device is divided into different functional devices so as to perform all or part of the preceding functions. In addition, the device provided in the preceding example belongs to the same concept as the method example and the product example, and the specific implementation process of the device is described in detail in the product example, which is not repeated here.

It is to be understood that the numbering of the steps described herein only exemplarily shows a possible execution sequence of the steps. In some other examples, the preceding steps may also be executed in a different order, for example, two steps with different numbers are performed at the same time, or two steps with different numbers are performed in an order reverse to the order shown in the figure, which is not limited in the examples of the present application.

Those of ordinary skill in the art can understand that all or part of the steps for implementing the preceding examples may be performed by hardware or may be performed by relevant hardware instructed by a program, and the program may be stored in a computer-readable storage medium. The preceding storage medium may be a read-only memory, a magnetic disk, an optical disk or the like.

What is claimed is:

1. A torque output tool, comprising:
a motor;
a housing for accommodating the motor;
an output shaft for outputting torque;
a gearbox mechanism for transmitting power between the motor and the output shaft;
an operating mechanism for a user to operate;
a load determination device for determining a load;
an operation amount determination device for determining a current operation amount of the operating mechanism; and
a control device for increasing a rotational speed of the motor when the load increases and the current operation amount is unchanged.

2. The torque output tool of claim 1, wherein the control device is used for adjusting a current original pulse-width modulation (PWM) signal to a target PWM signal in the case where the load increases and the current operation amount is unchanged, and the target PWM signal has a greater pulse width than the original PWM signal.

3. The torque output tool of claim 1, wherein the operating mechanism is coupled to a sliding rheostat.

4. The torque output tool of claim 3, wherein the operation amount determination device is used for acquiring a first analog signal outputted by the sliding rheostat at a current moment and determining the current operation amount based on the first analog signal.

5. The torque output tool of claim 4, wherein the operation amount determination device is further used for acquiring a second analog signal outputted by the sliding rheostat at an earlier moment that is separated from the current moment by a preset time.

6. The torque output tool of claim 5, wherein, when a variation between the first analog signal and the second analog signal is within a preset range, the current operation amount is determined to be unchanged.

7. The torque output tool of claim 1, wherein the load determination device is further used for acquiring a current rotational speed of the motor.

8. The torque output tool of claim 7, wherein, when the current rotational speed decreases, the load is determined to gradually increase.

9. The torque output tool of claim 1, wherein the control device is used for increasing the rotational speed of the motor when the motor operates at an initial startup rotational speed, the load gradually increases, and the current operation amount is unchanged and wherein the current operation amount corresponds to the initial startup rotational speed.

10. The torque output tool of claim 9, wherein the initial startup rotational speed of the motor is less than or equal to 100 revolutions per minute (rpm).

11. The torque output tool of claim 9, wherein the control device is further used for controlling the motor at a first PWM frequency when the motor operates at the initial startup rotational speed.

12. The torque output tool of claim 11, wherein the motor is controlled at a second PWM frequency when the motor does not operate at the initial startup rotational speed, and the first PWM frequency is lower than the second PWM frequency.

13. The torque output tool of claim 12, wherein the first PWM frequency is 1 to 8 kHz when the motor operates at 100 rpm or less, and the second PWM frequency is greater than or equal to 10 kHz when the motor does not operate at 100 rpm or less.

14. The torque output tool of claim 1, further comprising an impact mechanism, wherein the gearbox mechanism is connected to the motor and the impact mechanism, and the impact mechanism is used for generating an impact force.

15. The torque output tool of claim 1, wherein the operating mechanism is configured to be a trigger for starting up the motor.

16. A torque output tool, comprising:
a motor;
a housing for accommodating the motor;
an output shaft for outputting torque;
a gearbox mechanism for transmitting power between the motor and the output shaft;
an operating mechanism for a user to operate; and
a control mechanism for determining a load and a current operation amount of the operating mechanism and increasing a rotational speed of the motor when the load gradually increases and the current operation amount is unchanged.

17. A control method for a torque output tool, comprising:
determining a load;
determining a current operation amount of an operating mechanism of the torque output tool; and
increasing a rotational speed of a motor of the torque output tool when the load gradually increases and the current operation amount is unchanged.

18. The control method of claim 17, wherein determining the current operation amount of the operating mechanism of the torque output tool comprises acquiring a first analog signal outputted by a sliding rheostat coupled to the operating mechanism at a current moment and determining the current operation amount based on the first analog signal.

19. The control method of claim 18, further comprising acquiring a second analog signal outputted by the sliding rheostat at an earlier moment that is separated from the current moment by a preset time and determining that the current operation amount is unchanged when a variation between the first analog signal and the second analog signal is within a preset range.
